(19) United States
(12) Patent Application Publication
(10) Pub. No.: US 2026/0089572 A1
(43) Pub. Date: Mar. 26, 2026

(54) METHOD AND APPARATUS FOR CHANNEL ACCESS IN ENERGY HARVEST-BASED COMMUNICATION SYSTEM

(71) Applicant: ELECTRONICS AND TELECOMMUNICATIONS RESEARCH INSTITUTE, Daejeon (KR)

(72) Inventors: Chanho YOON, Daejeon (KR); Byung-Jae KWAK, Daejeon (KR); Kyeongpyo KIM, Daejeon (KR)

(21) Appl. No.: 19/210,932

(22) Filed: May 16, 2025

(30) Foreign Application Priority Data
May 17, 2024 (KR) 10-2024-0064782
May 16, 2025 (KR) 10-2025-0064077

(51) Int. Cl. H04W 28/20; H02J 50/00; H04W 72/0446

(52) U.S. Cl. CPC H04W 28/20; H02J 50/001; H04W 72/0446

(57) ABSTRACT

A method of a device may comprise: receiving, from a reader, a first subframe including information on channel access resources for harvesting rate stages; determining a channel access resource according to a harvesting rate of the device, based on the information on the channel access resources; receiving a carrier wave from the reader; generating a backscattered signal including a second subframe by reflecting the carrier wave; and transmitting the backscattered signal to the reader by using the channel access resource.

### CROSS-REFERENCE TO RELATED APPLICATIONS

This application claims priority to Korean Patent Applications No. 10-2024-0064782, filed on May 17, 2024, and No. 10-2025-0064077, filed on May 16, 2025, with the Korean Intellectual Property Office (KIPO), the entire contents of which are hereby incorporated by reference.

### BACKGROUND

### 1. Technical Field

The present disclosure relates to a channel access technique in an energy harvest-based communication system, and more particularly, to a channel access technique for a device performing uplink transmission based on backscattering.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In such information and communication technology, the Internet of Things (IoT) can attract significant attention, as it can improve industrial production efficiency and enhance the comfort of daily life. In IoT technology, IoT devices can operate without batteries. These devices can harvest the necessary energy from radio signals transmitted by a nearby wireless device and can transmit signals by backscattering the received radio signals. Therefore, a channel access method may be required to enable the IoT devices to access the wireless device.

### SUMMARY

To address the above-described problems, the present disclosure is directed to providing a channel access method and apparatus for performing uplink transmission based on backscattering in an energy harvesting-based communication system.

A channel access method in an energy harvesting-based communication system according to a first exemplary embodiment of the present disclosure, performed by a device, may comprise: receiving, from a reader, a first subframe including information on channel access resources for harvesting rate stages; determining a channel access resource according to a harvesting rate of the device, based on the information on the channel access resources; receiving a carrier wave from the reader; generating a backscattered signal including a second subframe by reflecting the carrier wave; and transmitting the backscattered signal to the reader by using the channel access resource.

The determining of the channel access resource may comprise: calculating the harvesting rate of the device; determining a harvesting rate stage including the harvesting rate; and determining the channel access resource corresponding to the determined harvesting rate stage based on information on the channel access resources for the harvesting rate stages.

The transmitting of the backscattered signal may comprise: determining a random back-off value based on a reference for determining the random back-off value; and transmitting the backscattered signal to the reader in the channel access resource, after a random back-off duration according to the random back-off value elapses.

The transmitting of the backscattered signal after the random back-off duration according to the random back-off value elapses may comprise: determining whether the random back-off duration according to the random back-off value elapses; and in response to determining that the random back-off duration elapses, transmitting the backscattered signal to the reader using a slotted ALOHA scheme at a start of a first slot after the random back-off duration elapses.

The transmitting of the backscattered signal may comprise: identifying a channel access subband as the channel access resource; and transmitting the backscattered signal to the reader using the identified channel access subband.

The method may further comprise: waiting for reception of a response signal from the reader for a predefined time; and in response to the response signal not being received for the predefined time, adjusting a random back-off value used for transmitting the backscattered signal in the channel access resource.

A channel access method in an energy harvesting-based communication system according to a second exemplary embodiment of the present disclosure, performed by a reader, may comprise: transmitting, to a device, a first subframe including information on channel access resources for harvesting rate stages; receiving, from the device, a backscattered signal including a second subframe through a channel access resource selected according to an energy harvesting rate of the device based on the information on the channel access resources; and transmitting a response signal for the backscattered signal to the device.

When the channel access resources are channel access durations, the information on the channel access resources for the harvesting rate stages may include at least one of information on a range of harvesting rates included in each of the harvesting rate stages or information on a channel access duration for each of the harvesting rate stages.

When the channel access resources are channel access subbands, the information on the channel access resources for the harvesting rate stages may include at least one of information on a range of harvesting rates included in each of the harvesting rate stages or information on a channel access subband for each of the harvesting rate stages.

The first subframe may include at least one of a first preamble, a synchronization signal, first control information, or first data, and the second subframe may include at least one of a second preamble, second control information, or second data.

A channel access apparatus in an energy harvest-based communication system according to a third exemplary embodiment of the present disclosure, implemented as a device, may comprise: a processor, and the processor may cause the device to perform: receiving, from a reader, a first subframe including information on channel access resources for harvesting rate stages; determining a channel access resource according to a harvesting rate of the device, based on the information on the channel access resources; receiving a carrier wave from the reader; generating a backscattered signal including a second subframe by reflecting the carrier wave; and transmitting the backscattered signal to the reader by using the channel access resource.

In the determining of the channel access resource, the processor may further cause the device to perform: calculating the harvesting rate of the device; determining a harvesting rate stage including the harvesting rate; and determining the channel access resource corresponding to the determined harvesting rate stage based on information on the channel access resources for the harvesting rate stages.

In the transmitting of the backscattered signal, the processor may further cause the device to perform: determining a random back-off value based on a reference for determining the random back-off value; and transmitting the backscattered signal to the reader in the channel access resource, after a random back-off duration according to the random back-off value elapses.

In the transmitting of the backscattered signal after the random back-off duration according to the random back-off value elapses, the processor may further cause the device to perform: determining whether the random back-off duration according to the random back-off value elapses; and in response to determining that the random back-off duration elapses, transmitting the backscattered signal to the reader using a slotted ALOHA scheme at a start of a first slot after the random back-off duration elapses.

According to the present disclosure, the reader can inform the devices of channel access resources corresponding to respective energy harvesting rate stages. Each device can calculate its harvesting rate and transmit a subframe to the reader using a backscattered signal, based on channel access resources corresponding to the calculated harvesting rate. The device can transmit the subframe while minimizing collisions, thereby enabling efficient utilization of the provided radio channel resources.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a conceptual diagram illustrating exemplary embodiments of subframes transmitted between a reader and a device.

FIG. 4 is a conceptual diagram illustrating exemplary embodiments of a forward link preamble.

FIG. 5 is a conceptual diagram illustrating exemplary embodiments of a forward link preamble.

FIG. 6 is a conceptual diagram illustrating an exemplary embodiment of a section for repeatedly transmitting a forward link preamble.

FIG. 7 is a conceptual diagram illustrating exemplary embodiments of a section for repeatedly transmitting a forward link synchronization sequence.

FIG. 8 is a conceptual diagram illustrating exemplary embodiments of a section for repeatedly transmitting a forward link synchronization sequence.

FIG. 9 is a conceptual diagram illustrating exemplary embodiments of a section for transmitting control information and data.

FIG. 10 is a conceptual diagram illustrating exemplary embodiments of a section for transmitting control information and data.

FIG. 11 is a conceptual diagram illustrating exemplary embodiments of various environments between a reader and devices.

FIG. 12 is a conceptual diagram illustrating exemplary embodiments of a channel access method in an energy harvesting-based communication system.

FIG. 13 is a conceptual diagram illustrating exemplary embodiments of a channel access method in an energy harvesting-based communication system.

FIG. 14 is a conceptual diagram illustrating exemplary embodiments of a channel access method in an energy harvesting-based communication system.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

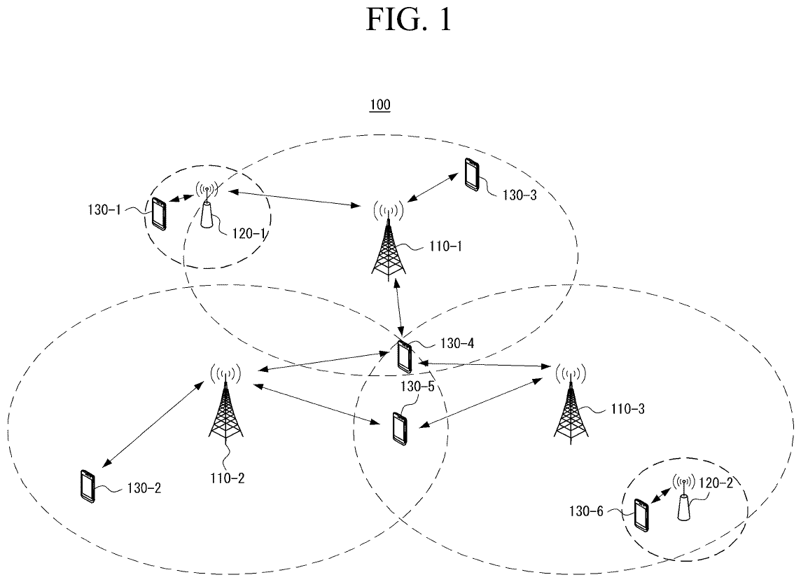

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, orthogonal frequency division multiple access (OFDMA) based communication protocol, single-carrier FDMA (SC-FDMA) based communication protocol, non-orthogonal multiple access (NOMA) based communication protocol, space division multiple access (SDMA) based communication protocol, or the like. Each of the plurality of communication nodes may have the following structure.

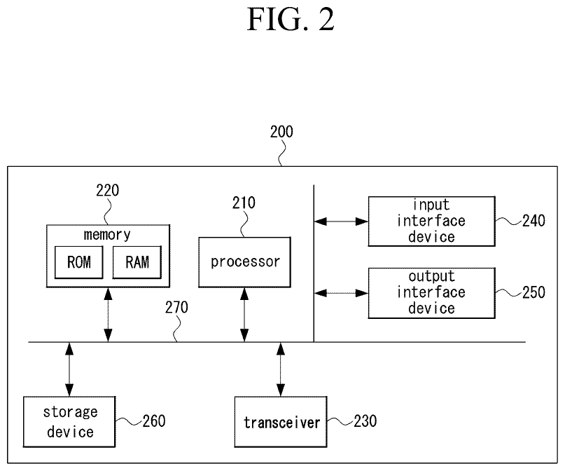

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), 5G Node B (gNB), base transceiver station (BTS), radio base station, radio transceiver, access point (AP), access node, road side unit (RSU), digital unit (DU), cloud digital unit (CDU), radio remote head (RRH), radio unit (RU), transmission point (TP), transmission and reception point (TRP), relay node, or the like. Each of the plurality of terminals 130-1, 130-2, 130-3, 130-4, 130-5, and 130-6 may be referred to as terminal, access terminal, mobile terminal, station, subscriber station, mobile station, portable subscriber station, node, device, or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New Radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

In 4G Long Term Evolution (LTE) and 5G New Radio (NR), each generation has evolved with objectives that surpass the requirements of the previous generation. For instance, in terms of maximum transmission rate and capacity, 5G NR targets up to 20 times the performance of 4G LTE. To achieve this, 5G NR employs new frequency bands, such as the 3.5 GHz band. It also enhances cellular system capacity through wide bandwidth allocation, the use of multiple antennas in massive multiple-input multiple-output (MIMO) configurations, multiple transmission and reception radio frequency (RF) chains, and multiple spatial layers. Furthermore, 5G NR can meet these performance goals by employing beamforming (BF), considering the wide bandwidth and propagation characteristics of the 28 GHz millimeter wave (mmWave) band, which primarily uses time division duplexing (TDD).

The sixth-generation cellular network (6G) may aim to achieve a maximum capacity and transmission rate up to 20 times greater than those of 5G NR. In addition to improving spectral efficiency, 6G may also pursue the integration of various devices, such as IoT-based sensors, in alignment with the trends of the Fourth Industrial Revolution. Examples of such integrated device elements may include non-terrestrial networks (NTNs), integrated sensing and communication (ISAC), and ambient IoT (AIoT), which extends the concept of radio-frequency identification (RFID) systems into the broader application domain of IoT.

In 6G communication systems, AIoT may be a system comprising energy-harvesting-based devices. The devices may not be terminals such as smartphones, but rather receiving/transmitting devices based on energy harvesting. The devices may be designed in a form similar to currently commercialized and deployed RFID devices.

An RFID terminal may operate based on power derived from always-on ambient energy provided externally (i.e. radio waves of weak intensity in a resonant frequency range). The base station-terminal relationship in a cellular system may be replaced with a reader-device relationship. A downlink signal may require allocation of a physical time duration to allow the device to sufficiently harvest energy and activate RF components. A configuration of the downlink signal may include a duration for estimating a temporal synchronization reference time of the downlink signal after the wake-up time of the device, and a duration for decoding a control signal and a data signal protected by cyclic redundancy check (CRC), encryption, and interleaving.

The device may not be able to store a sufficient amount of energy to transmit signals in an ultra-high frequency (UHF) band, which is essentially a passband. The device may include a built-in battery or may generate a passband carrier wave (CW) on its own. However, a device with a built-in battery may not represent a basic device model.

A basic device may employ a backscatter-based uplink transmission technique, in which it immediately modulates and reflects a carrier wave received from the reader, similar to the operation of RFID. The base station may transmit a CW while simultaneously receiving a signal from the device.

A 6G usage scenario may aim to provide connectivity to IoT devices, based on the operating principles of RFID, within an existing 3GPP network in order to identify or access the devices. In other words, RFID and AIoT systems may be similar at the physical layer. However, RFID and AIoT may have different system-wide objectives.

In existing RFID, a device and a reader may be assumed to have a default one-to-one relationship. In the AIoT system, devices and a reader may have an n-to-one relationship, where n is a positive integer. Even in RFID, n-to-one scenarios may also be considered, allowing multiple terminals to access the channel simultaneously. When multiple devices transmit at the same time, a random access channel scheme may be used to reduce the probability of collisions.

In the AIoT system, various time and frequency resources provided by a base station based on the NR technical specifications may be utilized while maximizing the use of existing physical channel structures and implemented signal processing units. The AIoT system may differ in terms of frequency division duplexing (FDD) frequency regulations and in its system topology, which utilizes an NR terminal as a reader. In FDD systems, since uplink and downlink channels are allocated to different frequency bands, it is difficult to use an uplink signal simultaneously in the downlink frequency band due to regulatory constraints. The reader may be a base station, a terminal, or a relay. In the AIoT system, devices may exist in various forms and have different energy harvesting capabilities. Depending on the environment, the amount of energy harvested by each device may also vary.

The above-described backscatter-based uplink transmissions may cause problems when multiple devices perform uplink transmission simultaneously. Uplink signal collisions may be mitigated by applying random back-off to reduce the probability of collisions. As the number of devices increases, a longer back-off time needs to be provided to lower the collision probability. A device with limited energy storage capacity may face difficulties due to the short available back-off time caused by its limited stored energy. In particular, a device with a low energy harvesting rate may have fewer uplink transmission opportunities, since it needs to wait until fully charged before attempting transmission, unlike devices with higher harvesting rates.

The devices may have different capabilities and may have different energy harvesting rates depending on physical distances from the reader. A synchronization signal and a frame structure of the reader that take such a situation into account may be required. An uplink channel access method may be needed to provide a fair opportunity to the devices. An objective protocol that is able to serve as a reference point recognized by the devices may be required.

The present disclosure proposes a random access-based radio channel access method in consideration of AIoT devices having different energy harvesting capabilities. The present disclosure proposes a structure that enables frame time synchronization to be acquired by recognizing synchronization signals transmitted from the reader, even when the AIoT devices having different energy harvesting capabilities and having different physical distances from the reader cannot harvest the same amount of energy per unit time. The present disclosure proposes a method for efficiently waking up AIoT devices that may have different energy harvesting capabilities and different physical distances from the reader, and therefore different energy harvesting rates.

Examples of a mobile communication system to which the present disclosure is applicable may include 3GPP LTE and NR communication systems. In the present disclosure, ‘downlink’ may refer to communication from a next generation nodeB (gNB) to a terminal, and ‘uplink’ may refer to communication from a terminal to a gNB. The terminal may refer to a communication device carried by a user. The terminal may also be referred to as a mobile station (MS), a user terminal (UT) or user equipment (UE), a subscriber station (SS), or a wireless device. The device may refer to a wireless device utilizing energy harvesting.

Based on the 3GPP radio access network technical specification, a first layer, which is a physical layer, may provide an information transfer service to a higher layer by using physical channels. The physical layer may be connected to a medium access control (MAC) layer located above through transport channels. Data may be delivered between the MAC layer and the physical layer through the transport channels. Data may be delivered between the physical layers of a transmitting side and a receiving side through the physical channels. The physical channels may utilize time and frequency radio resources.

Specifically, the physical channels may be modulated by an orthogonal frequency division multiple access (OFDMA) scheme in the downlink, and may be modulated by a single carrier frequency division multiple access (SC-FDMA) scheme or an OFDMA scheme in the uplink. A reader (e.g. a base station or a terminal) may perform downlink transmission by using a modulation scheme other than the OFDMA-based scheme. A device may perform uplink transmission by using a single carrier modulation scheme based on backscattering, not based on the SC-FDMA scheme.

### 1. Method for Configuring a Frame Serving as an Energy Detection and Timing Synchronization Reference

### 1-1. Method for Configuring a Subframe and Frame of a Forward Link for Energy Detection/Harvesting/Backscattering

A reader may periodically transmit signals through a forward link (FL), which corresponds to a downlink, for energy harvesting and backscatter-based communication of devices. Alternatively, the reader may semi-persistently transmit signals through the forward link for energy harvesting and backscatter-based communication of devices. A device may receive the signals through the forward link. The signal may include a forward link subframe (FL subframe). The forward link may correspond to a downlink from the reader to the device. The device may transmit signals to the reader through a backward link, which corresponds to an uplink. The reader may receive the signals from the device through the backward link. The signal may include a backward link subframe (BL subframe). The backward link may correspond to an uplink from the device to the reader.

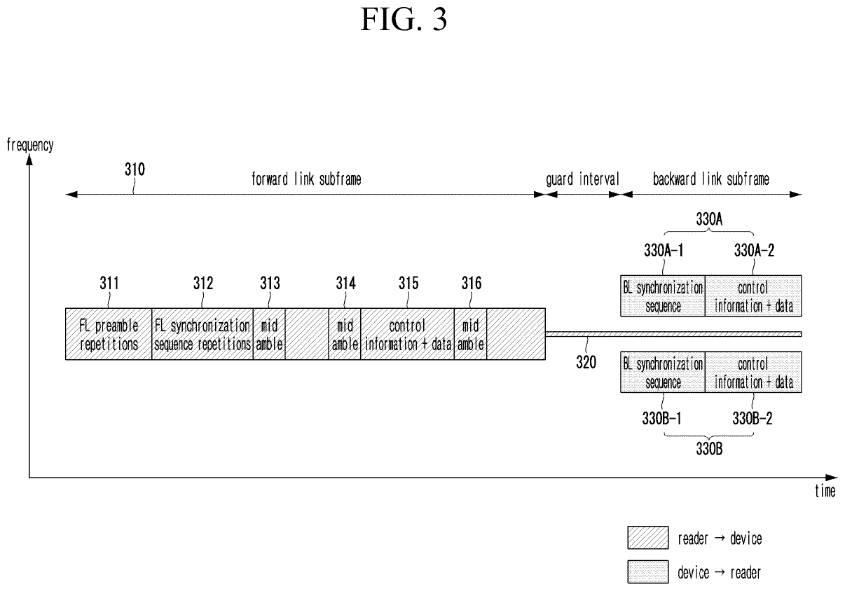

FIG. 3 is a conceptual diagram illustrating exemplary embodiments of subframes transmitted between a reader and a device.

Referring to FIG. 3, the reader may transmit a forward link subframe 310 to the device using a specific frequency. The device may receive the forward link subframe from the reader through the specific frequency. The FL subframe 310 may include a section 311 for repeatedly transmitting an FL preamble, a section 312 for repeatedly transmitting an FL synchronization sequence, a section 313 for transmitting a first midamble, a section 314 for transmitting a second midamble, a section 315 for transmitting control information and data, and a section 316 for transmitting a third midamble. The section for repeatedly transmitting the FL preamble may be arranged at the beginning of the FL subframe.

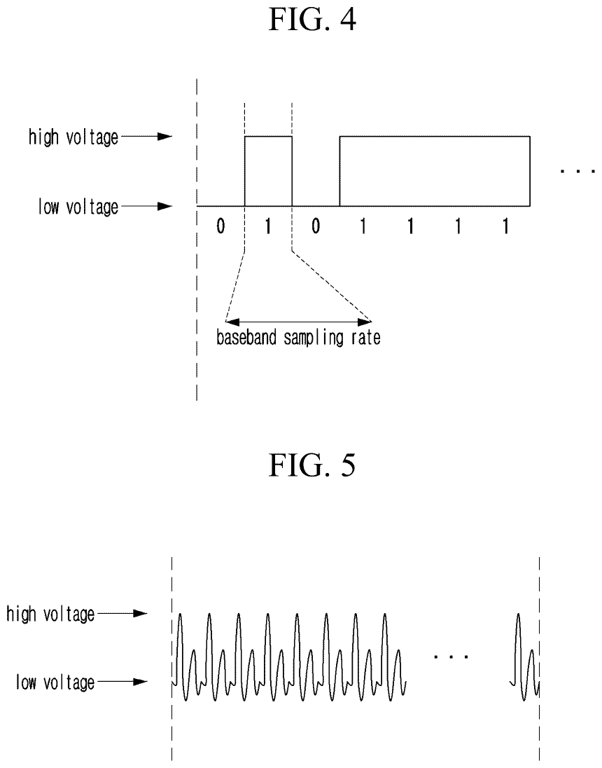

FIG. 4 is a conceptual diagram illustrating exemplary embodiments of a forward link preamble.

Referring to FIG. 4, the FL preamble may be configured as a pulse interval encoding (PIE) modulated signal, as used in RFID systems. The PIE modulated signal may have different energy magnitudes to distinguish data-0 bits and data-1 bits. In the PIE modulated signal, data-0 may correspond to a low voltage, and data-1 may correspond to a high voltage. A transmission time of data-0 and data-1 each may be defined based on a baseband sampling rate.

FIG. 5 is a conceptual diagram illustrating exemplary embodiments of a forward link preamble.

Referring to FIG. 5, the FL preamble may be configured in the form of a sinc function pulse train, where peak components (i.e. high voltage) and trough components (i.e. low voltage) exhibit a large amplitude difference. The reader may transmit this FL preamble to the device, and the device may receive it in the same form. The device may clearly recognize the amplitude level variations in the received FL preamble in the form of a sinc function pulse train.

A signal generation block of the reader in the AIoT system may be designed in consideration of a system frame transmitted in-band or in a guard band, based on an OFDM signal. In the AIoT system, applying PIE as the FL preamble may be challenging from a timing perspective. Compared to PIE, a sinc function pulse train may be more suitable for aligning with a 1 ms time slot composed of 14 OFDM symbols with cyclic prefixes (CP), based on a 15 kHz subcarrier spacing.

PIE may have energy spread over the duration of an OFDM symbol. The sinc function pulse train may have a large on/off ratio. With its large on/off ratio, the sinc function pulse train may allow the device to detect the peak energy more easily compared to PIE. The peak of the sinc function pulse train may have concentrated energy. As a result, the downlink coverage may be enhanced.

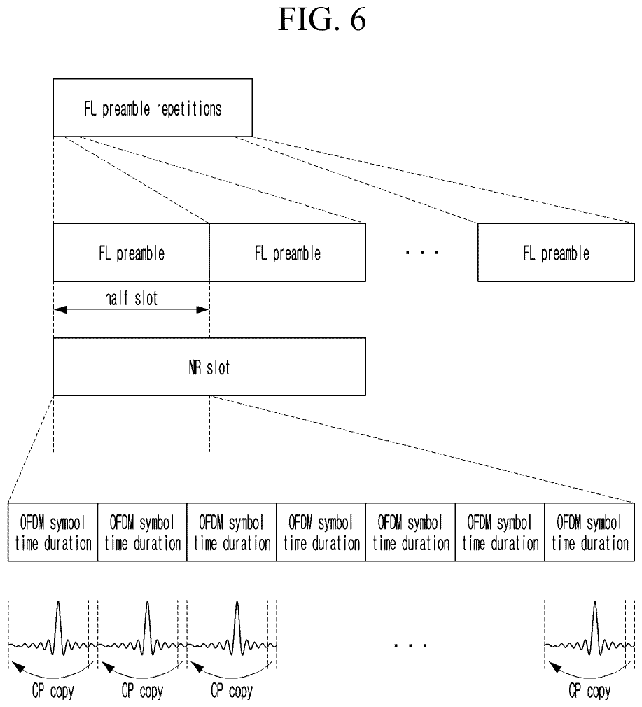

FIG. 6 is a conceptual diagram illustrating an exemplary embodiment of a section for repeatedly transmitting a forward link preamble.

Referring to FIG. 6, the section for repeatedly transmitting the FL preamble may be configured with multiple sub-sections, each used to transmit the FL preamble. The length of each sub-section may correspond to a half-slot duration. The FL preamble may be configured as a pulse train composed of one or more sinc functions, with each pulse located within an OFDM symbol duration matching that of NR. In addition, the sinc function pulse train may be aligned to half-slot boundaries with a 0.5 ms interval, consistent with the NR slot duration. In other words, for a 15 kHz subcarrier spacing, the sinc function pulse train may span 7 OFDM symbols per half slot.

As another option, when the reader configures the FL preamble, the reader may generate a sinc function in the time domain (e.g. corresponding to (CP+OFDM time duration)) having a length of 71.875 us or 71.354 us based on a sample length calculated with a 15 kHz SCS, specifically, 1/15000 Hz/2048×(160+2048)=71.875 μs or 1/15000 Hz/2048×(144+2048)=71.354 μs. The reader may configure an FL preamble of a half-slot (or slot) length by combining the generated sinc functions.

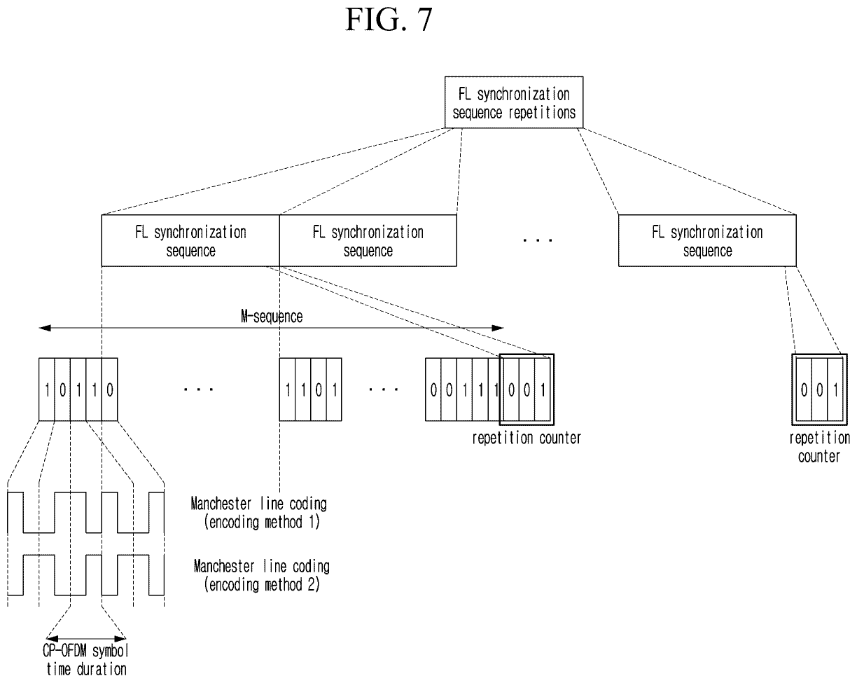

FIG. 7 is a conceptual diagram illustrating exemplary embodiments of a section for repeatedly transmitting a forward link synchronization sequence.

Referring to FIG. 7, the section for repeatedly transmitting the FL synchronization sequence may be configured with sub-sections, each used to transmit the FL synchronization sequence. The sub-section for transmitting the FL synchronization sequence may be repeated a predetermined number of times. The number of repetitions of the FL synchronization sequence may be indicated by a repetition counter. The FL synchronization sequence may be configured as a signal sequence for cell identifier (ID) detection and timing synchronization. The FL synchronization sequence may be configured as a single M-sequence. Each binary bit of the synchronization sequence may be represented as a signal of a Manchester line code combined with an on/off keying (OOK) modulation scheme, within a time duration of one OFDM symbol. An encoding method 1 of the Manchester line coding and an encoding method 2 of the Manchester line coding may be opposite in terms of signal representation.

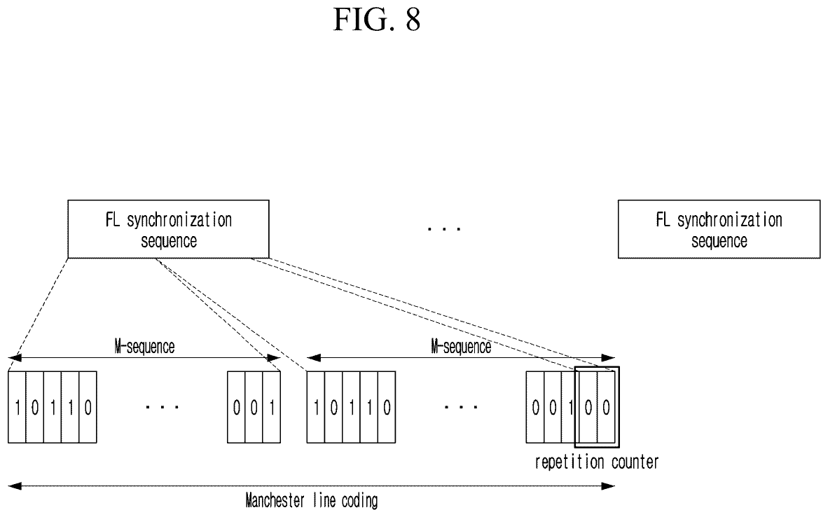

FIG. 8 is a conceptual diagram illustrating exemplary embodiments of a section for repeatedly transmitting a forward link synchronization sequence.

Referring to FIG. 8, the section for repeatedly transmitting the FL synchronization sequence may be configured with sub-sections, each used to transmit the FL synchronization sequence. As described above, the sub-section for transmitting the FL synchronization sequence may be repeated a predetermined number of times. The number of repetitions of the FL synchronization sequence may be indicated by a repetition counter. The FL synchronization sequence may be configured as a signal sequence for cell ID and timing synchronization acquisition. The FL synchronization sequence may be configured with two M-sequences. The reader may project the M-sequence into a time region having a length of 127 (or a length of 2ⁿ−1, where n is a positive integer) used in a primary synchronization signal (PSS). The reader may transmit a secondary synchronization signal (SSS) following the M-sequence. Timing synchronization may be acquired with the PSS alone. Each binary bit of the synchronization sequence may be represented by a signal of a Manchester line code combined with an on/off keying modulation scheme, within a time duration of one OFDM symbol. When the reader assumes or supports a higher data rate, the synchronization sequence may represent m bits with one OFDM symbol. m may be a positive integer.

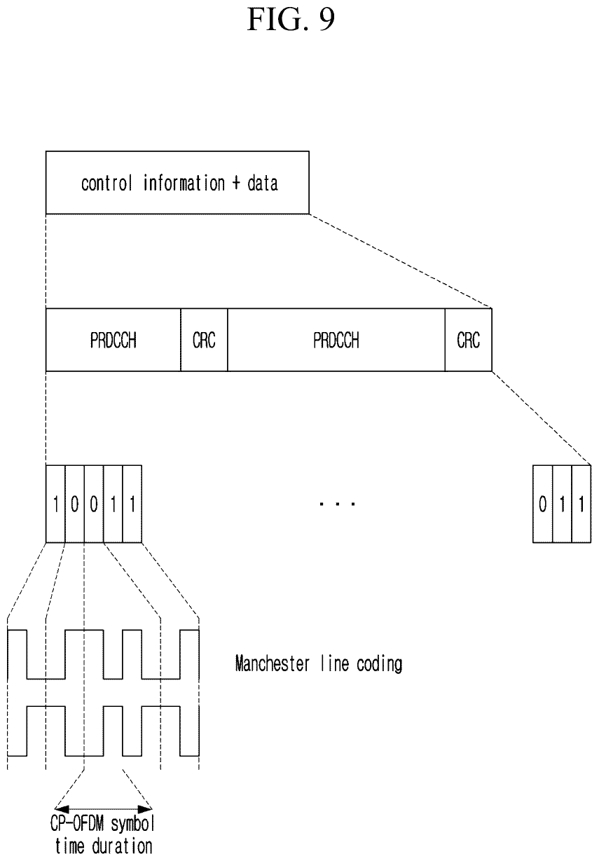

FIG. 9 is a conceptual diagram illustrating exemplary embodiments of a section for transmitting control information and data.

Referring to FIG. 9, the section for transmitting control information and data may include a sub-section for transmitting a physical reader to device control channel (PRDCCH), a sub-section for transmitting a first CRC, a sub-section for transmitting a physical reader to device shared channel (PRDSCH), and a sub-section for transmitting a second CRC.

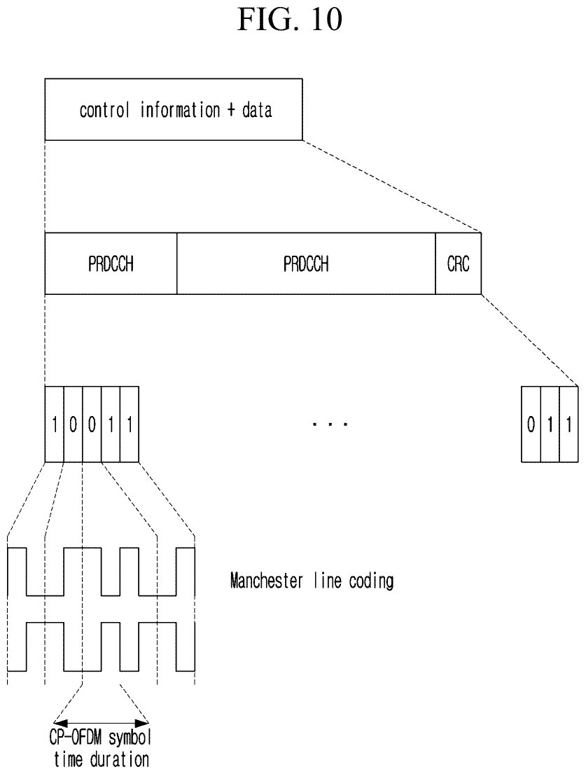

FIG. 10 is a conceptual diagram illustrating exemplary embodiments of a section for transmitting control information and data.

Referring to FIG. 10, the section for transmitting control information and data may include a sub-section for transmitting a PRDCCH, a sub-section for transmitting a PRDSCH, and a sub-section for transmitting a CRC.

Referring to FIG. 9 and FIG. 10, the reader may transmit a PRDCCH with an added CRC to the device. The device may receive the PRDCCH with the CRC and may verify validity of the PRDCCH using the CRC. Initialization bits of a shift register of the CRC may be composed of m₁ initialization bits of a shift register that outputs the M-sequence of the PSS and m₂ initialization bits of a shift register that outputs the M-sequence of the SSS. m₁ and m₂ may be positive integers. For example, the initialization bits of the shift register of the CRC may be configured to have 14 bits by concatenating 7 initialization bits for generating the M-sequence of the PSS with a length of 127 and 7 initialization bits for generating the M-sequence of the SSS with a length of 127. A bit width of the initialization bits of the shift register of the CRC may have various lengths derived from information configuring the FL synchronization sequence, as well as 14 bits. The reader may explicitly notify the device of the initialization bits of the shift register of the CRC through a cell radio network temporary identifier (C-RNTI). The device may receive the C-RNTI from the reader and may acquire the initialization bits of the shift register of the CRC based on the received C-RNTI. In addition, the reader may transmit information indicating which CRC bit width is associated with a given C-RNTI to a separately designated device through the PRDSCH.

The reader may transmit the PRDCCH prior to transmission of the PRDSCH. The PRDCCH may include a response for a device that attempted random access, a time index in a frame unit higher than a subframe, a duplication index of a repeatedly transmitted FL subframe, and random back-off seeds according to harvesting rates.

The reader may broadcast a specific purpose of FL transmission. For example, the reader may perform an inquiry to determine the presence or absence of adjacent devices. The reader may transmit an inquiry signaling signal for determining the presence or absence of adjacent devices to the adjacent devices. Each of the adjacent devices may receive the inquiry signaling signal from the reader and may transmit a response signal to the reader. The reader may receive the response signal from the adjacent device and may determine the presence or absence of the adjacent device.

The reader may transmit data to a specific device or a specific device group so that the device or the specific device group records the received data. To this end, the reader may deliver the purpose of recording the data to the device by including the purpose in the PRDCCH or the PRDSCH. The device may receive the PRDCCH or the PRDSCH including the purpose of recording the data from the reader and may identify the purpose of recording the data. The reader may transmit data corresponding to the purpose of recording to the device. The device may receive and record the data from the reader. As described above, when the reader notifies the purpose of recording the data to the specific device or the specific device group, the probability of collisions caused when performing BL transmission based on unnecessary random access may be reduced.

The reader may transmit signaling information instructing a device that responded to the inquiry of the reader to switch to sleep mode. The device may receive the signaling information instructing the device to switch to sleep mode from the reader and may switch to the sleep mode according to the received signaling information.

The PRDSCH may include content similar to a MAC control element (CE) used in LTE/NR, binary bits to be recorded in the device, and the like. The PRDSCH may include information related to BL scheduling. The PRDSCH may include a signal indicating a BL transmission timing based on an environment and class of the device and a back-off reference time counter value.

Referring again to FIG. 3, the reader may transmit a carrier wave 320 to the device. The device may receive the carrier wave from the reader. The device may harvest and store energy from the carrier wave received from the reader. The device may reflect the carrier wave received from the reader and may transmit a first backscattered signal including a first BL subframe 330A to the reader using a first specific frequency. The device may reflect the carrier wave received from the reader and may transmit a second backscattered signal including a second BL subframe 330B to the reader using a second specific frequency. The reader may receive the first BL subframe 330A from the device through the first specific frequency. The reader may receive the second BL subframe 330B from the device through the second specific frequency.

The first BL subframe 330A may include a second 330A-1 for transmitting a first BL synchronization sequence and a second 330A-2 for transmitting first control information and data. The second BL subframe 330B may include a section 330B-1 for transmitting a second BL synchronization sequence and a section 330B-2 for transmitting second control information and data. The control information may correspond to a physical device to reader control channel (PDRCCH), and the data may correspond to a physical device to reader shared channel (PDRSCH).

### 1-2. Method for Configuring a Forward Link in Consideration of Capabilities and Environments/Distances of Various Devices

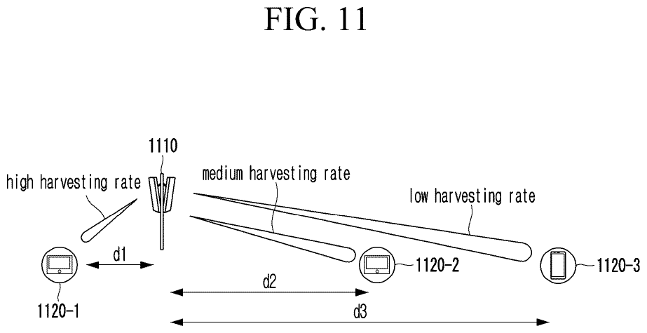

FIG. 11 is a conceptual diagram illustrating exemplary embodiments of various environments between a reader and devices.

Referring to FIG. 11, a reader 1110 and a first device 1120-1 may be separated by a distance of d1. The reader may transmit a carrier wave to the first device. The first device may receive the carrier wave from the reader and may harvest energy from the received carrier wave at a high harvesting rate. The reader 1110 and a second device 1120-2 may be separated by a distance of d2. The reader may transmit the carrier wave to the second device. The second device may receive the carrier wave from the reader and may harvest energy from the received carrier wave at a medium harvesting rate. The reader 1110 and a third device 1120-3 may be separated by a distance of d3. The reader may transmit the carrier wave to the third device. The third device may receive the carrier wave from the reader and may harvest energy from the received carrier wave at a low harvesting rate. d1, d2, and d3 may be positive real numbers, units thereof may be meters, and a relationship d1<d2<d3 may be established.

The distance between the reader and the first device, the distance between the reader and the second device, and the distance between the reader and the third device may be different from each other. The harvesting rate between the reader and the first device, the harvesting rate between the reader and the second device, and the harvesting rate between the reader and the third device may be different from each other. A synchronization sequence within an FL subframe may be repeated a predetermined number of times.

A path loss of a radio wave received at the first device, which is closest to the reader, may be relatively lower than a path loss at the second device or a path loss at the third device. The first device may have relatively higher received power compared to the second device or the third device. Accordingly, the first device may have the high harvesting rate. The first device may receive an energy harvesting preamble (EHP) from the reader in a section for transmitting the energy harvesting preamble. Upon receiving the energy harvesting preamble, the first device may immediately perform energy detection. The first device may quickly harvest energy due to the high harvesting rate and may decode a synchronization sequence.

On the other hand, the third device, which is physically the farthest from the reader, may not be able to detect energy even after the section for transmitting the energy harvesting preamble has passed, due to the attenuation of radio power. In consideration of this situation, the reader may repeatedly transmit the synchronization signal sequence to the third device. The third device may compensate for insufficient energy using the synchronization signal sequence repeatedly transmitted by the reader, thereby enabling smooth operation. The reader may insert midambles between consecutive synchronization sequences to configure the repeated FL synchronization sequences.

One of the first device, the second device, or the third device may wake up from an idle or sleep state by an internal counter. The one of the devices may harvest energy for only a certain time duration due to a clock drift. The one of the devices may fail to detect a first synchronization sequence when attempting synchronization sequence detection. In this case, low correlation values measured by the device may degrade timing estimation performance.

Similarly, one of the first device, the second device, or the third device may wake up early from a sleep state due to early clock sampling, which is opposite to drift. The one of the devices may receive and process a synchronization sequence starting from a certain portion of the EHP, which may negatively affect timing estimation performance based on correlation values. In consideration of such situations, the reader may repeatedly transmit the synchronization sequence.

When repeatedly transmitting the synchronization sequence, the reader may use a repetition counter with n bits at the end of the FL synchronization sequence to distinguish which repeated synchronization sequence is being transmitted in the sub-section for transmitting the FL synchronization sequence. The device may recognize the number of repetitions of the received synchronization sequence through the repetition counter.

### 2. Backscatter-Based Channel Access Method of a Device

### 2-1. Random Channel Access Method in Consideration of Capabilities and Environments/Distances of Various Devices, Signaling Configuration Method According to Situations, and Backward Link Transmission Method

Each of the devices may attempt random access to the reader using a slotted Additive Links On-line Hawaii Area (ALOHA) scheme. In this scheme, a predetermined time duration is divided into multiple time slots to enable the transmission of BL subframes to the reader. Each device may divide a channel into multiple time slots using the slotted ALOHA scheme and may transmit a BL subframe at the beginning of its allocated time slot. The reader may receive BL subframes from the devices.

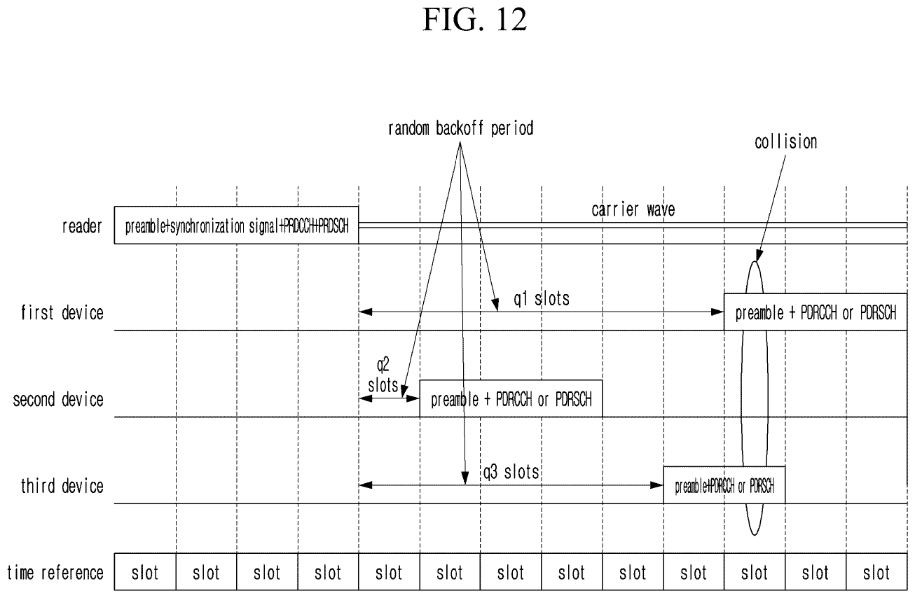

FIG. 12 is a conceptual diagram illustrating exemplary embodiments of a channel access method in an energy harvesting-based communication system.

Referring to FIG. 12, the reader may transmit an FL subframe to devices (i.e. first to third devices). The FL subframe may include an FL preamble, an FL synchronization signal, a PRDCCH, a PRDSCH, and the like. The FL subframe may serve as a wake-up signal. The reader may transmit a carrier wave to the devices. A duration in which the reader transmits the carrier wave may be a duration in which the devices are able to transmit BL subframes, and may be referred to as a BL transmission duration.

Each of the devices may receive the carrier wave and may harvest energy from the received carrier wave. Each of the devices may generate a backscattered signal by reflecting the carrier wave and may transmit a BL subframe to the reader through the backscattered signal. The reader may receive the backscattered signal including the BL subframe from the device and may acquire the BL subframe.

Each of the devices may transmit the BL subframe to the reader in accordance with its allocated time slot by applying the slotted ALOHA scheme. The BL subframe may include a preamble (including a synchronization signal), control information, data (PDRSCH), a midamble, and the like. The control information of the BL subframe may be represented as a PDRCCH. The data of the BL subframe may be represented as a PDRSCH. Each of the devices may transmit the data to the reader by performing channel encoding.

The reader may receive the BL subframes from the devices. Due to the large number of devices, the reader may simultaneously receive multiple BL subframes, which may cause collisions among the BL subframes. To mitigate such collisions, each of the devices may perform random back-off. In other words, each of the devices may determine a random back-off duration. Each of the devices may apply the determined random back-off duration to the BL transmission duration and may transmit the BL subframe to the reader after the random back-off duration elapses. The random back-off duration may be in slot units. Alternatively, the random back-off duration may be in frame units. A temporal reference of a slot may be the same as a time reference of a slot in LTE/NR. The random back-off duration may be determined, for example, as q slots. q may be a random back-off value and may be a positive integer.

The reader may transmit, through the FL subframe, a random back-off value generation range or a random back-off seed value to each of the devices so that each of the devices determines its random back-off duration. The random back-off value generation range or the random back-off seed value may be referred to as a reference for determining the random back-off duration. The random back-off value generation range may be within the BL transmission duration. A minimum value of the random back-off value generation range may be X, and a maximum value thereof may be Y. The BL transmission duration may be indicated by slot indexes, for example, from 0 to 100. In this case, the random back-off value generation range may be set to X=30 to Y=60. The random back-off seed value q_{rand} may be 40, for example. X, Y, and q_{rand} may be positive integers.

Each of the devices may receive, from the reader through the FL subframe, the random back-off value generation range or the random back-off seed value required to determine its random back-off duration. Each of the devices may determine the random back-off value based on the received random back-off value generation range or the random back-off seed value.

For example, the first device may determine q1 as its random back-off value by using the random back-off value generation range or the random back-off seed value received from the reader. The first device may transmit the BL subframe to the reader after elapsing the random back-off duration determined as q1 slots according to the determined random back-off value. The reader may receive the BL subframe from the first device.

For example, the second device may determine q2 as its random back-off value by using the random back-off value generation range or the random back-off seed value received from the reader. The second device may transmit the BL subframe to the reader after elapsing the random back-off duration determined as q2 slots according to the determined random back-off value. The reader may receive the BL subframe from the second device.

For example, the third device may determine q3 as a random back-off value by using the random back-off value generation range or the random back-off seed value received from the reader. The third device may transmit the BL subframe to the reader after elapsing the random back-off duration determined as q3 slots according to the determined random back-off value. The reader may receive the BL subframe from the third device.

In the above-described manner, each of the devices may transmit a subframe to the reader by using a backscattered signal generated by reflecting the carrier wave after the random back-off duration corresponding to the random back-off value elapses. In other words, each of the devices may determine whether the random back-off duration corresponding to the random back-off value elapses. Each of the devices may generate a backscattered signal by reflecting the carrier wave upon determining that the random back-off duration elapses. Each of the devices may, based on the slotted ALOHA scheme, transmit the subframe to the reader by using the backscattered signal at the beginning of the first slot after the random back-off duration elapses.

The reader may receive the BL subframes from devices. In this case, the BL subframe received by the reader from the first device and the BL subframe received from the third device may collide. The random back-off value generation range or the random back-off seed value may have different values for each device based on a capability or a harvesting rate.

Meanwhile, distances between the devices and the reader may vary. Capabilities of the devices may differ from one another. A specific device that is close to the reader may transmit a BL subframe to the reader immediately upon beginning to harvest a carrier wave, due to a high harvesting rate. On the other hand, a device that is distant from the reader may be unable to transmit a BL subframe to the reader until a sufficient amount of energy is harvested from the carrier wave to transmit the BL subframe. Accordingly, a transmission delay may occur. Therefore, when configuring a BL transmission duration for allowing the devices to transmit BL subframes according to the slotted ALOHA scheme, the reader may divide the duration in the time domain and configure different channel access durations based on the harvesting rates.

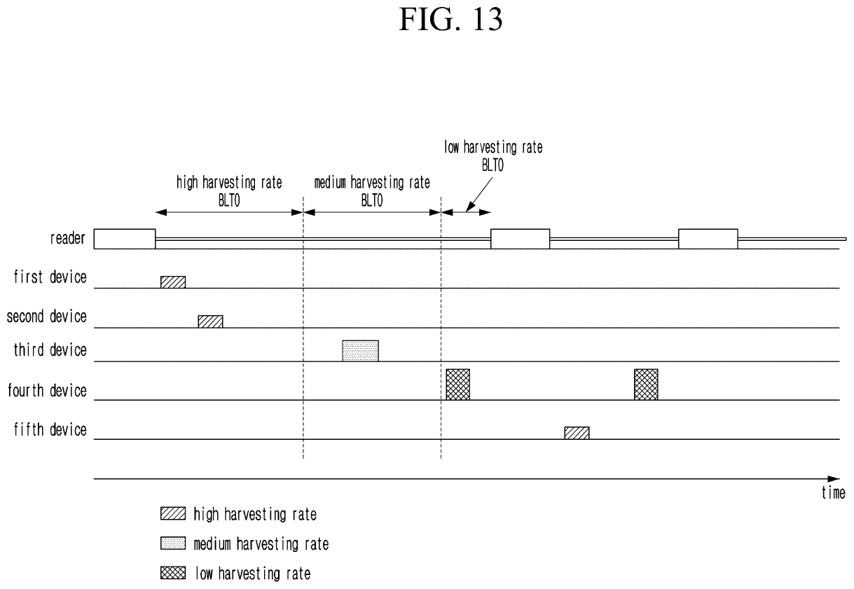

FIG. 13 is a conceptual diagram illustrating exemplary embodiments of a channel access method in an energy harvesting-based communication system.

Referring to FIG. 13, the reader may transmit an FL subframe to devices (i.e. first to fifth devices). The FL subframe may include an FL preamble, an FL synchronization signal, a PRDCCH, a PRDSCH, and the like. The FL subframe may serve as a wake-up signal. The reader may transmit a carrier wave to the devices. Each of the devices may receive the carrier wave and harvest energy from the received carrier wave. Each of the devices may reflect the carrier wave to generate a backscattered signal, and may transmit a BL subframe to the reader using the backscattered signal. The reader may receive the backscattered signal including the BL subframe from the device and acquire the BL subframe.

Each of the devices may apply the slotted ALOHA scheme to transmit the BL subframe to the reader in accordance with its allocated time slot. The BL subframe may include a preamble (including a synchronization signal), control information, data (PDRSCH), a midamble, and the like. The control information of the BL subframe may be represented as a PDRCCH. The data of the BL subframe may be represented as a PDRSCH. Each of the devices may perform channel encoding on the data and transmit the data to the reader.

The reader may receive BL subframes from the devices. Due to the large number of devices, the reader may simultaneously receive multiple BL subframes, causing collisions between the BL subframes. In order to mitigate the collisions, each of the devices may perform a random back-off.

When configuring BL transmission resources for enabling the devices to transmit BL subframes according to the slotted ALOHA scheme, the reader may divide the duration in the time domain and configure different channel access durations according to the harvesting rates.

A harvesting rate p may indicate a time-based ratio at which energy collectible from the carrier wave is actually converted into a useful form of energy such as electrical energy, and may be represented by Equation 1 below. P_{harvested} may denote an energy (power) actually harvested and stored or supplied to a circuit by a device per unit time. P_{incident} may denote a power of the carrier wave that arrives at an antenna of the device per unit time. A reference time may be, for example, in milliseconds.

$$p = ( {P}_{harvested} / {P}_{incident} ) \times \times 100 \% \qquad [ Equation 1 ]$$

For example, when a harvesting rate falls within 10% to 30%, the reader may classify the rate as belonging to a slow harvesting rate stage. When a harvesting rate falls within 31% to 60%, the reader may classify the rate as belonging to a medium harvesting rate stage. When a harvesting rate falls within 61% to 100%, the reader may classify the rate as belonging to a high harvesting rate stage.

The reader may configure channel access durations in a BL transmission duration according to the harvesting rate stages. The reader may divide the duration in which the devices are able to transmit BL subframes into a slow harvesting rate BL time occasion (BLTO) duration, a medium harvesting rate BLTO duration, and a high harvesting rate BLTO duration. The slow harvesting rate BLTO duration may correspond to a slow harvesting rate contention window, the medium harvesting rate BLTO duration may correspond to a medium harvesting rate contention window, and the high harvesting rate BLTO duration may correspond to a high harvesting rate contention window.

In other words, the reader may configure a slow channel access duration for the slow harvesting rate stage in the BL transmission duration, may configure a medium channel access duration for the medium harvesting rate stage in the BL transmission duration, and may configure a fast channel access duration for the high harvesting rate stage in the BL transmission duration. The BL transmission duration may be, for example, from slot indexes 0 to 100 based on a transmission time of the carrier wave. The reader may configure the fast channel access duration as slot indexes 0 to 29, the medium channel access duration as slot indexes 30 to 59, and the slow channel access duration as slot indexes 60 to 100. The slow harvesting rate BLTO duration may be the slow channel access duration, the medium harvesting rate BLTO duration may be the medium channel access duration, and the high harvesting rate BLTO duration may be the fast channel access duration.

The reader may notify the devices of a start slot index and an end slot index of each duration through the FL subframe. The start slot index and end slot index of each duration may be start information and end information of each duration. The reader may notify the devices of an indicator k of each duration through the FL subframe. The indicator of each duration may indicate the start slot index of each duration. For example, k may be a positive integer (e.g. 30).

The devices may receive information on the start slot index and end slot index of each of the slow harvesting rate BLTO duration, the medium harvesting rate BLTO duration, and the high harvesting rate BLTO duration from the reader. The devices may receive information on a duration indicator indicating the start slot index of the slow harvesting rate BLTO duration, the medium harvesting rate BLTO duration, and the high harvesting rate BLTO duration from the reader.

Each of the devices may calculate its harvesting rate. Each of the devices may determine which harvesting rate stage corresponds to the calculated harvesting rate. Each of the devices may transmit the BL subframe to the reader in the BLTO duration according to a harvesting rate stage that includes the calculated harvesting rate. In other words, each of the devices may transmit the BL subframe to the reader in a duration determined by the start slot index and end slot index of the BLTO duration corresponding to the harvesting rate stage that includes the calculated harvesting rate.

Each of the devices may perform a random back-off in the BLTO duration corresponding to the harvesting rate stage that includes the calculated harvesting rate. Each of the devices may determine a random back-off duration in the BLTO duration corresponding to the harvesting rate stage that includes the calculated harvesting rate. Each of the devices may apply the determined random back-off duration to the BL transmission duration. Each of the devices may transmit the BL subframe to the reader after the random back-off duration elapses. The random back-off duration may be in slot units. The random back-off duration may be determined, for example, as q slots. q may be a random back-off value and may be a positive integer.

The reader may transmit a random back-off value generation range or a random back-off seed value to each of the devices through the FL subframe so that each of the devices determines its random back-off duration. The random back-off value generation range or the random back-off seed value may be a reference for determining the random back-off duration.

Each of the devices may receive, from the reader through the FL subframe, the random back-off value generation range or the random back-off seed value required to determine the random back-off duration. Each of the devices may determine its random back-off value using the received random back-off value generation range or random back-off seed value.

Each of the devices may determine a random back-off duration according to the determined random back-off value in a corresponding BLTO duration. Each of the devices may apply the determined random back-off duration. Each of the devices may transmit a BL subframe to the reader after the random back-off duration elapses. The random back-off duration may be determined, for example, as q slots. q may be a random back-off value and may be a positive integer.

Meanwhile, each of the devices may calculate its harvesting rate. Each of the devices may determine which harvesting rate stage corresponds to the calculated harvesting rate. The device may transmit a BL subframe to the reader in a BLTO duration corresponding to the harvesting rate stage including the calculated harvesting rate. For this purpose, the device may determine a random back-off value for transmitting the BL subframe to the reader in the BLTO duration using Equation 2.

The reader may notify the devices of values k, Y, X, and q_{rand} through the FL subframe so that each of the devices determines the random back-off duration in the BLTO duration using Equation 2. k may be a duration indicator of each channel access duration and may have a range including values [0, N), where N may be a positive integer. Y may be a maximum value of the BL transmission duration, and X may be a minimum value of the BL transmission duration. Grand may be the random back-off seed value. The values k, Y, X, and q_{rand} may be positive integers. EHᵣₐₜₑ may indicate a harvesting rate stage based on the calculated harvesting rate. For example, 0 may represent the high harvesting rate stage, 1 may represent the medium harvesting rate stage, and 3 may represent the slow harvesting rate stage.

$$q = max ( min ( {EH}_{rate} k + {q}_{rand} , Y ) , X ) \qquad [ Equation 2 ]$$

For example, the first device may belong to the high harvesting rate stage and may transmit a BL subframe to the reader in the high harvesting rate BLTO duration. The reader may receive the BL subframe from the first device. For example, the second device may belong to the high harvesting rate stage and may transmit a BL subframe to the reader in the high harvesting rate BLTO duration. The reader may receive the BL subframe from the second device.

For example, the third device may belong to the medium harvesting rate stage and may transmit a BL subframe to the reader in a medium harvesting rate BLTO duration. The reader may receive the BL subframe from the third device. For example, the fourth device may belong to the slow harvesting rate stage and may transmit a BL subframe to the reader in a slow harvesting rate BLTO duration. The reader may receive the BL subframe from the fourth device. For example, the fifth device may belong to the high harvesting rate stage and may transmit a BL subframe to the reader in the high harvesting rate BLTO duration. The reader may receive the BL subframe from the fifth device.

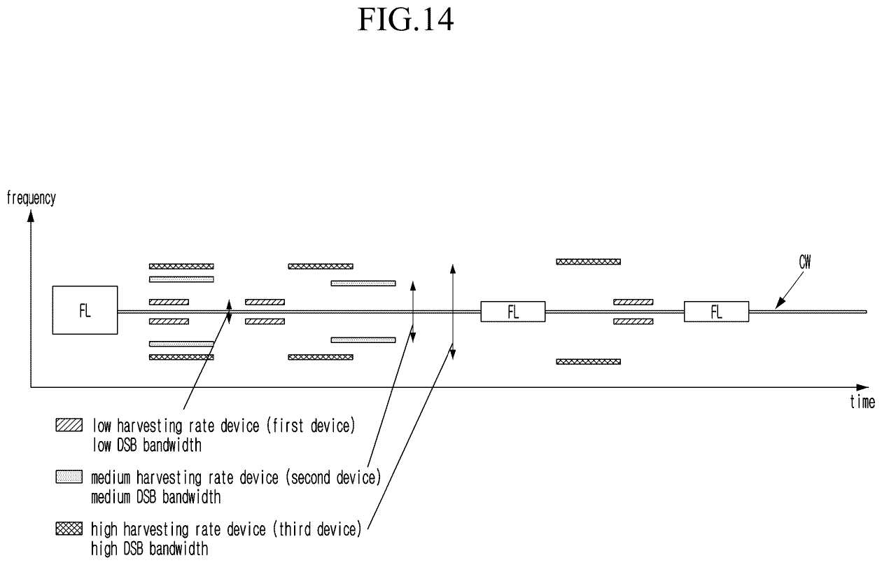

FIG. 14 is a conceptual diagram illustrating exemplary embodiments of a channel access method in an energy harvesting-based communication system.

Referring to FIG. 14, the reader may transmit an FL subframe to devices (i.e. first to third devices). The FL subframe may include an FL preamble, an FL synchronization signal, a PRDCCH, a PRDSCH, and the like. The FL subframe may serve as a wake-up signal. The reader may transmit a carrier wave to the devices. Each of the devices may receive the carrier wave and may harvest energy from the received carrier wave. Each of the devices may reflect the carrier wave to generate a backscattered signal, and may transmit a BL subframe to the reader using the backscattered signal. The reader may receive the backscattered signal including the BL subframe from the device and may acquire the BL subframe.

Each of the devices may apply the slotted ALOHA scheme to transmit the BL subframe to the reader in accordance with its allocated time slot. The BL subframe may include a preamble (including a synchronization signal), control information, data (PDRSCH), a midamble, and the like. The control information of the BL subframe may be represented as a PDRCCH. The data of the BL subframe may be represented as a PDRSCH. Each of the devices may perform channel coding on the data and transmit the data to the reader.

The reader may receive BL subframes from the devices. Due to the large number of devices, the reader may simultaneously receive multiple BL subframes, causing collisions among the BL subframes. In order to mitigate such collisions, each of the devices may perform a random back-off.

When configuring BL transmission resources for allowing the devices to transmit BL subframes according to the slotted ALOHA scheme, the reader may divide a frequency band into different channel access subbands according to the harvesting rates. The reader may configure channel access subbands in BL transmission resources according to the harvesting rate stages. The reader may divide a frequency band available for the devices to transmit the BL subframes into a slow harvesting rate BL frequency occasion subband (BLFO), a medium harvesting rate BLFO subband, and a high harvesting rate BLFO subband.

In other words, the reader may configure a slow channel access subband for the slow harvesting rate stage, a medium channel access subband for the medium harvesting rate stage, and a fast channel access subband for the high harvesting rate stage in the BL transmission resources. The BL transmission resources may be time resources from slot indexes 0 to 100 based on a transmission time of the carrier wave, for example. Additionally, the BL transmission resources may be configured as a predetermined frequency range centered on the frequency of the carrier wave.

The fast channel access subband may correspond to a subband located far from the frequency of the carrier wave in the frequency domain (e.g. in the form of dual side-band (DSB) or single side-band (SSB) in amplitude modulation). The medium channel access subband may correspond to a subband slightly distant from the frequency of the carrier wave in the frequency domain (e.g. in the form of DSB or SSB in amplitude modulation). The slow channel access subband may correspond to a subband close to the frequency of the carrier wave in the frequency domain (e.g. in the form of DSB or SSB in amplitude modulation).

The third device located close to the reader may have a high energy harvesting rate and may transmit a BL subframe to the reader using a channel access subband located far from the frequency of the carrier wave in the frequency domain (e.g. in the form of DSB or SSB in amplitude modulation). The channel access subband located far from the frequency of the carrier wave in the frequency domain may be suitable when a frequency shift from the carrier wave occurs relatively significantly.

The second device that is located far from the reader may have a medium energy harvesting rate and may transmit a BL subframe to the reader using a channel access subband that is slightly distant from the carrier wave frequency in the frequency domain (e.g. in the form of DSB or SSB in amplitude modulation). The first device that is located very far from the reader may have a low energy harvesting rate and may transmit a BL subframe to the reader using a channel access subband that is close to the carrier wave frequency in the frequency domain (e.g. in the form of DSB or SSB in amplitude modulation). Since the first device located far from the reader has a low harvesting rate for accumulated energy, the first device may transmit a BL subframe in a subband (or DSB/SSB) close to the carrier frequency.

The reader may notify the devices of a start frequency and an end frequency of each subband through the FL subframe. The start frequency and the end frequency of each subband may be start frequency information and end frequency information of each subband. The reader may notify the devices of an indicator of each subband through the FL subframe. The indicator of each subband may indicate, for example, the start frequency of each subband.

The devices may receive information on the start frequency and end frequency of each of the slow harvesting rate BLFO subband, the medium harvesting rate BLFO subband, and the high harvesting rate BLFO subband from the reader. The devices may receive information on a subband indicator indicating the start frequency of each of the slow harvesting rate BLFO subband, the medium harvesting rate BLFO subband, and the high harvesting rate BLFO subband from the reader.

Each of the devices may calculate its harvesting rate. Each of the devices may determine which harvesting rate stage corresponds to the calculated harvesting rate. Each of the devices may transmit a BL subframe to the reader in a BLFO subband corresponding to the harvesting rate stage including the calculated harvesting rate. In other words, each of the devices may transmit a BL subframe to the reader in a subband determined by the start frequency and end frequency of the BLFO subband corresponding to the harvesting rate stage including the calculated harvesting rate. Each of the devices may transmit a BL subframe to the reader in a subband determined by a subband indicator of the BLFO subband corresponding to the harvesting rate stage including the calculated harvesting rate.

For example, the first device may belong to the slow harvesting rate stage and may transmit a BL subframe to the reader in the slow harvesting rate BLFO subband. The reader may receive the BL subframe from the first device. For example, the second device may belong to the medium harvesting rate stage and may transmit a BL subframe to the reader in the medium harvesting rate BLFO subband. The reader may receive the BL subframe from the second device.

For example, the third device may belong to the high harvesting rate stage and may transmit a BL subframe to the reader in the high harvesting rate BLFO subband. The reader may receive the BL subframe from the third device.

Meanwhile, when performing BL random access in the AIoT system, a device having a high priority may exist. In such a situation, the reader may allocate a channel access subband with relatively low collision occurrence to the device having a high priority for BL transmission. Alternatively, the reader may allocate a range of maximum values for random back-off smaller than an average value to the device having a high priority. The reader may simultaneously apply the above-described slotted ALOHA channel access scheme with differentiated time durations of random back-off values according to the harvesting rates, time-based differentiation (e.g. BLTO durations), or frequency-based differentiation (e.g. BLFO subbands) in the AIoT system.

2.2 Random Channel Access Method of a Device that has Detected a BL Collision, Signaling Configuration Method According to a Situation, and BL Transmission Method

The AIoT system may have a problem in which a probability of collision increases as BL transmissions of the devices increase. The present disclosure provides a method of efficiently using radio resources. When the reader receives a BL subframe from a device, the reader may transmit an acknowledgement (ACK) to the device. The device may receive the acknowledgement from the reader and may confirm the transmission of the BL subframe.

The reader may receive a BL subframe from the device, and a collision may occur in the BL subframe. The reader may not transmit an acknowledgement (ACK) to the device. The device may not receive the acknowledgement from the reader. The device may estimate that a collision has occurred.

In such a case, a conventional wireless communication system may perform retransmission. However, since the AIoT system does not guarantee the availability of energy, retransmission may not be performed. However, if the device determines that a collision has occurred previously, the device may consider the collision when performing back-off thereafter. In order to allow the device to take the occurrence of the collision into account, Equation 2 may be modified as Equation 3.

$$q = max ( min ( {EH}_{rate} k + {cq}_{rand} , Y ) , X ) \qquad [ Equation 3 ]$$

In Equation 3, c may represent whether a collision has occurred and may be a natural number other than 0. The reader may notify the device of the value of c. The device may receive and apply the value of c from the reader. The device may also arbitrarily set the value of c.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a device, comprising:
receiving, from a reader, a first subframe including information on channel access resources for harvesting rate stages;
determining a channel access resource according to a harvesting rate of the device, based on the information on the channel access resources;
receiving a carrier wave from the reader;
generating a backscattered signal including a second subframe by reflecting the carrier wave; and
transmitting the backscattered signal to the reader by using the channel access resource.

2. The method according to claim 1, wherein the determining of the channel access resource comprises:
calculating the harvesting rate of the device;
determining a harvesting rate stage including the harvesting rate; and
determining the channel access resource corresponding to the determined harvesting rate stage based on information on the channel access resources for the harvesting rate stages.

3. The method according to claim 1, wherein the transmitting of the backscattered signal comprises:
determining a random back-off value based on a reference for determining the random back-off value; and
transmitting the backscattered signal to the reader in the channel access resource, after a random back-off duration according to the random back-off value elapses.

4. The method according to claim 3, wherein the transmitting of the backscattered signal after the random back-off duration according to the random back-off value elapses comprises:
determining whether the random back-off duration according to the random back-off value elapses; and
in response to determining that the random back-off duration elapses, transmitting the backscattered signal to the reader using a slotted ALOHA scheme at a start of a first slot after the random back-off duration elapses.

5. The method according to claim 1, wherein the transmitting of the backscattered signal comprises:
identifying a channel access subband as the channel access resource; and
transmitting the backscattered signal to the reader using the identified channel access subband.

6. The method according to claim 1, further comprising:
waiting for reception of a response signal from the reader for a predefined time; and
in response to the response signal not being received for the predefined time, adjusting a random back-off value used for transmitting the backscattered signal in the channel access resource.

7. A method of a reader, comprising:
transmitting, to a device, a first subframe including information on channel access resources for harvesting rate stages;
receiving, from the device, a backscattered signal including a second subframe through a channel access resource selected according to an energy harvesting rate of the device based on the information on the channel access resources; and
transmitting a response signal for the backscattered signal to the device.

8. The method according to claim 7, wherein when the channel access resources are channel access durations, the information on the channel access resources for the harvesting rate stages includes at least one of information on a range of harvesting rates included in each of the harvesting rate stages or information on a channel access duration for each of the harvesting rate stages.

9. The method according to claim 7, wherein when the channel access resources are channel access subbands, the information on the channel access resources for the harvesting rate stages includes at least one of information on a range of harvesting rates included in each of the harvesting rate stages or information on a channel access subband for each of the harvesting rate stages.

10. The method according to claim 7, wherein the first subframe includes at least one of a first preamble, a synchronization signal, first control information, or first data, and the second subframe includes at least one of a second preamble, second control information, or second data.

11. A device comprising: a processor, wherein the processor causes the device to perform:
receiving, from a reader, a first subframe including information on channel access resources for harvesting rate stages;
determining a channel access resource according to a harvesting rate of the device, based on the information on the channel access resources;
receiving a carrier wave from the reader;
generating a backscattered signal including a second subframe by reflecting the carrier wave; and
transmitting the backscattered signal to the reader by using the channel access resource.

12. The device according to claim 11, wherein in the determining of the channel access resource, the processor further causes the device to perform:
calculating the harvesting rate of the device;
determining a harvesting rate stage including the harvesting rate; and
determining the channel access resource corresponding to the determined harvesting rate stage based on information on the channel access resources for the harvesting rate stages.

13. The device according to claim 11, wherein in the transmitting of the backscattered signal, the processor further causes the device to perform:
determining a random back-off value based on a reference for determining the random back-off value; and
transmitting the backscattered signal to the reader in the channel access resource, after a random back-off duration according to the random back-off value elapses.

14. The device according to claim 13, wherein in the transmitting of the backscattered signal after the random back-off duration according to the random back-off value elapses, the processor further causes the device to perform:
determining whether the random back-off duration according to the random back-off value elapses; and
in response to determining that the random back-off duration elapses, transmitting the backscattered signal to the reader using a slotted ALOHA scheme at a start of a first slot after the random back-off duration elapses.
